(19) United States
(12) Patent Application Publication
(10) Pub. No.: US 2011/0065408 A1
(43) Pub. Date: Mar. 17, 2011

(54) MISMATCHED DELAY BASED INTERFERENCE CANCELLATION DEVICE AND METHOD

(76) Inventors: Peter Kenington, Chepstow (GB); Dirk Neumann, Ulm (DE)

(21) Appl. No.: 12/561,605

(22) Filed: Sep. 17, 2009

(51) Int. Cl. H04B 1/10

(52) U.S. Cl. 455/303

(57) ABSTRACT

An interference signal cancellation device comprises a signal splitter, a delay element and a signal combiner. The signal splitter distributes a disturbed signal to a first signal path and a second signal path. The delay element is situated in at least one of the first signal path and the second signal path for introducing a relative delay between a first signal in the first signal path and a second signal in the second signal path. The signal combiner combines the first signal and the second signal. An interference signal within the disturbed signal is substantially reduced within the signal combiner. A method for interference signal cancellation is also proposed. Furthermore, a computer program product with instructions for the manufacture and a computer program product enabling a processor to carry out the method for interference signal cancellation are also proposed.

### CROSS REFERENCE TO OTHER APPLICATIONS

The present application is related to a patent application entitled “Frequency shifting based interference cancellation device and method” (Attorney Docket No. 4424-P04911US0) filed concurrently herewith. The entire disclosure of the foregoing application is incorporated herein by reference.

### FIELD OF THE INVENTION

The field of the present invention relates to an interference signal cancellation device, used for example, in a receiver used in a base transceiver station (BTS) of a mobile communications network. The field of the present invention further relates to a method for interference cancellation on a disturbed signal comprising an interference signal. The field of the present invention also relates to a computer program product enabling a foundry to carry out the manufacture of an interference cancellation device, and to a computer program product enabling a processor to carry out the method for interference cancellation.

### BACKGROUND OF THE INVENTION

In a “classic” design of radio communication systems the transmitter and the receiver comprise hardware to ensure a certain degree of selectivity in the frequency band. The hardware can be filters, oscillators, mixers or other components. The dedicated hardware allows the transmitter or the receiver to be tuned to a relatively narrow frequency range, often termed “channel”.

A more modern concept is the so-called “software-defined radio system”. In the software-defined radio system, components that have typically been implemented in hardware (e.g. mixers, filters, amplifiers, modulators/demodulators, detectors etc.) are instead implemented using software. The software-defined radio system became interesting from a commercial point of view when digital circuits with sufficient calculating power became available at reasonable prices. The software-defined radio system makes it possible to use relatively generic electronic components because significant parts of the way a signal is processed can be defined in software. Thus, the software-defined radio system can be, in principle, updated to support new radio protocols or modifications in existing radio protocols.

Software-defined radio systems make use of analogue-to-digital converters or digital-to-analogue converters. The analogue-to-digital converters and the digital-to-analogue converters usually have a limited bandwidth, a limited frequency range and a limited dynamic range. Due to these limitations, the analogue-to-digital converter may not be able to process an incoming analogue signal in the intended manner, such as extracting a wanted signal at a specific frequency within a wideband analogue signal. This inability of the analogue-to-digital converter may be due to an insufficient signal-to-noise ratio or a strong blocker within the frequency range that is observed by the analogue-to-digital converter.

Mobile communications networks are still constantly developing with the aim to increase the volume of data that can be transmitted in a certain geographic region and within a certain time. This effort may lead to constantly evolving mobile communications standards so that the software-defined radio system appears to be a good choice for an operator of the mobile communications network. Base transceiver stations (BTS) operated by the mobile network operator can be updated and adapted to a number of future mobile communications standards. A well known standard for mobile communications networks is the GSM standard (Global System for Mobile Communications). The GSM standard has been in use for commercial applications since the early 1990's and continues to be used, at least in some regions. Other standards that may succeed the GSM standard are for example the UMTS and the LTE (Long Term Evolution) standards. The mobile communications standard may define certain tests that the equipment operating under this particular mobile communications standard needs to pass. For example, the specification of the GSM standard contains a blocker test for a GSM receiver. A blocker is a strong interfering signal of which the frequency is close to, or even within, the frequency range of the wanted signal. The GSM specification requires the signal blocker at −16 dBm or −25 dBm to be handled. At a level of −16 dBm a noise figure of 9 dB is permitted. This allows an attenuator to be switched in to reduce the blocker level. In the other case the blocker level is reduced to −25 dBm and the relaxation of using an attenuator is no longer permitted.

U.S. Pat. No. 4,739,518 issued to Beckley et al. describes a receiver interference suppression system. A received signal is distributed to two single paths, one of which provides a constant amplitude signal and the other of which provides a limited signal. The constant amplitude and the limited signals combine through a subtraction operation resulting in a significant attenuation of the interfering signal while causing only a small attenuation of a desired signal. The receiver interference suppressions system taught in U.S. Pat. No. 4,739,518 uses a limiter which typically creates broad band interference due to its severe non-linearity when limiting. In frequency modulation (FM) receivers, to which U.S. Pat. No. 4,739,518 relates, a broad band interference may be acceptable, since the carriers and blockers in a FM transmission system are typically constant-envelope and hence no loss of signal fidelity occurs when passing through a limiter. For a couple of transmission techniques other than FM the use of the limiter would create the same problem that the receiver interference suppression system is trying to solve, namely that of overload/non-linearity in the receive path, due to the presence of a strong interferer, causing distortion which masks a weak wanted signal and can also cause distortion of the wanted signal itself. This will result in a degradation of the error vector magnitude of the signal, for example, thereby making the signal difficult or impossible to demodulate. The teachings of the entire disclosure of U.S. Pat. No. 4,739,518 are incorporated herein by reference.

### SUMMARY OF THE INVENTION

It would be desirable to have a structure for cancelling a blocker or interference signal wherein such an interference cancellation structure would add no or only little broad band interference to the processed signal. It would also be desirable that such an interference cancellation structure works with a subsequent analogue-to-digital converter. To address at least one of these concerns and/or possible other concerns an interference signal cancellation device is proposed. The interference signal cancellation device comprises a signal splitter, a delay element and a signal combiner. The signal splitter distributes a disturbed signal to a first signal path and a second signal path. The first signal path and the second signal path have substantially linear behaviour. The delay element is located in the first signal path or the second signal path. In the alternative, both the first signal path and the second signal path could comprise an individual delay element. The delay element introduces a relative delay between a first signal in the first signal path and a second signal in the second signal path. The signal combiner combines the first signal and the second signal. An interference signal within the disturbed signal is substantially reduced within the signal combiner due to the relative delay difference between the two paths.

Under the assumption that the relative delay is chosen in correspondence to a main frequency of the interference signal, portions of the interference signal in the first signal path and the second signal path are substantially reduced out in the signal combiner due to a destructive superposition. The remainder of the disturbed signal, such as a wanted signal, is relatively unaffected by the introduced relative delay and the action of the signal combiner because the main frequency of the interference signal is different from a frequency of the wanted signal.

The interference signal cancellation device can be used in connection with a software-defined radio system, because the substantially linear behaviour of the first signal path and the second signal path prevents excessive intermodulation. Thus, the frequency range covered by the disturbed signal is not or at least only to a small extent, enlarged, diminished or shifted. This preservation of the covered frequency range usually reduces problems in a subsequent analogue-to-digital converter, such as increased noise level. A non-linearity in the first signal path and/or the second signal path would typically lead to a degradation of the error vector magnitude of the signal. A consequence of a high error vector magnitude is often a high received bit-error rate. Reducing or eliminating the non-linearities in the first signal path and the second signal path avoids these problems.

The delay element does not necessarily have to be a dedicated delay element but could be an element that is present anyway in the first signal path or the second signal path. For example, most types of filter introduce a delay. It is also possible to use a combination of a dedicated delay element and an element that is present in the first signal path or the second signal path and also introduces a delay.

At least one of the first signal path and the second signal path may comprise a filter. In a wideband signal it is possible that the relative delay causes a destructive superposition not only for the interference signal, but also at other frequencies. Depending on the application, it may not be desirable to cancel portions of the wideband signal at those frequencies where destructive superposition occurs. For example, it could be that a payload signal of another channel happens to be at a frequency that is affected by destructive superposition due to the relative delay. The filter in at least one of the first signal path and the second signal path is able to prevent such destructive superposition.

It would be desirable that the first signal and/or the second signal can be adjusted in amplitude and/or phase so that an interference signal portion present in the first signal and an interference signal portion present in the second signal can be matched for the best possible destructive superposition. This concern and/or possibly other concerns are addressed by at least one of the first signal path and the second signal path comprising at least one of a gain controller and a phase controller. The gain controller may be provided for adjusting an amplitude of at least one of the first signal and the second signal. The phase controller may be provided for adjusting a phase of at least one of the first signal and the second signal.

As an alternative to a gain controller and a phase controller the at least one of the first signal path and the second signal path may contain a vector modulator for adjusting at least one of: the amplitude of the first signal, the phase of the first signal, the amplitude of the second signal, and the phase of the second signal.

At least one of the first signal path and the second signal path may comprise an amplifier. Among other purposes, the amplifier may be useful to compensate for an attenuation of the first signal or the second signal. The attenuation of the first signal or the second signal might be caused by elements within the first signal path or the second signal path, respectively, such as the filter, the gain controller, the phase controller or the delay element.

It would be desirable that the interference signal cancellation device can be adjusted to cancel (or reduce) interference signals occurring at different frequencies. This aspect and/or possibly other aspects are addressed by the delay element having an adjustable delay.

The interference signal cancellation device may further comprise a cancellation controller. At least one of the first signal path and the second signal path may comprise at least one of a gain controller and a phase controller (or alternatively a vector modulator) for adjusting at least one of an amplitude of the first signal, a phase of the first signal, an amplitude of the second signal, and a phase of the second signal. The cancellation controller may be adapted to control the adjusting of at least one of the amplitude of the first signal, the phase of the first signal, the amplitude of the second signal, and the phase of the second signal. The function of the gain controller and of the phase controller has already been discussed above. Besides the delay element, the cancellation controller also controls the gain controller and/or the phase controller in the first signal path and/or the second signal path. In an alternative embodiment, it is possible that the delay element has a fixed delay and that the cancellation controller controls the phase controller in order to match the interference signal portion in the first signal path and the interference signal portion in the second signal path to achieve the desired destructive superposition.

It would be desirable that in a receiver structure having a plurality of similar or identical receive paths, such as in a receiver structure connected to an antenna array, interference signal cancellation could be achieved for all of the receive paths and with little structural overhead. This aspect and/or possible other aspects are addressed by the cancellation controller controlling a plurality of at least one of gain controllers and phase controllers, each one of the gain controllers or phase controllers being part of an individual receive path in a group of similar or identical receive paths. For example, if the group of similar or identical receive paths is connected to the antenna array, the relative phase of the interference signal within the individual receive path depends on the location of the interference signal source relative to the antenna array. The same is true for the phase of the wanted signal within the individual receive path and a location of the source of the wanted signal relative to the antenna array. The proposed arrangement allows an adjustment of the interference signal's amplitude and phase independent from any gain and phase adjustments for the desired signal.

The above-mentioned aspects may also be addressed by the interference signal cancellation device being adapted for a plurality of similar or identical receive paths, wherein the interference cancellation device further comprises an interference signal splitter and additional signal combiners in each one of the plurality of receive paths. The interference signal splitter may be adapted to distribute the first signal to the plurality of additional signal combiners. The additional signal combiners may be adapted to combine the distributed first signals with distributed second signals, each of the distributed second signals relayed by one of the plurality of receive paths, respectively.

The delay element may introduce a portion of the relative delay, wherein that portion introduced by the delay element is common for several or even all receive paths among the plurality of receive paths. The delay element may be regarded as “shared” between several or all receive paths. With a shared delay element the number of delay elements can be reduced possibly to a single delay element.

The interference signal cancellation device may further comprise a plurality of at least one of gain controllers and phase controllers acting on the distributed first signal.

The interference signal may be an in-band blocker or an out-band blocker.

The present disclosure further provides a method for interference cancellation on a disturbed signal comprising an interference signal. The method comprises splitting the disturbed signal into a first signal and a second signal, time delaying at least one of the first signal and the second signal by a relative delay between the first signal and the second signal, and combining the first signal and the second signal for substantially reducing the interference signal within the disturbed signal due to the introduced delay. The first signal and the second signal undergo substantially only linear processing between splitting and combining.

The method may further comprise identifying an interference signal by at least one of frequency, amplitude and phase, and adjusting the delay between the first signal and the second signal so as to optimize the cancelling (or reduction) of the interference signal.

The action of identifying an interference signal may comprise determining whether the disturbed signal causes an overload.

The present disclosure further provides a computer program product embodied on a computer-readable medium and the computer-readable medium comprising executable instructions for the manufacture of an interference cancellation device as described herein.

The present disclosure also provides a computer program product comprising instructions that enable a processor to carry out the method as described herein.

As far as technically meaningful, the technical features disclosed herein may be combined in any manner. The interference signal cancellation device and the method for interference cancellation may be implemented in software, in hardware, or as a combination of both software and hardware.

### BRIEF DESCRIPTION OF THE DRAWINGS

FIG. 1 shows a receiver arrangement with an interference signal cancellation device according to a first possible configuration.

FIG. 2 shows a receiver arrangement with an interference signal cancellation device according to a second possible configuration.

FIG. 3 shows a receiver arrangement with an interference signal cancellation device according to a third possible configuration.

FIG. 4 shows a receiver arrangement with two interference signal cancellation devices.

FIG. 5 shows a multi-receiver arrangement with a plurality of interference signal cancellation devices.

FIG. 6 shows a multi-receiver arrangement with a common interference signal cancellation device.

FIG. 7 shows a flowchart of one possible algorithm for the identification of an in-band-blocker.

FIG. 8 illustrates the form of the cancellation characteristic and its effect on the blocker signal and on a wanted signal.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect can be combined with a feature of a different aspect or aspects.

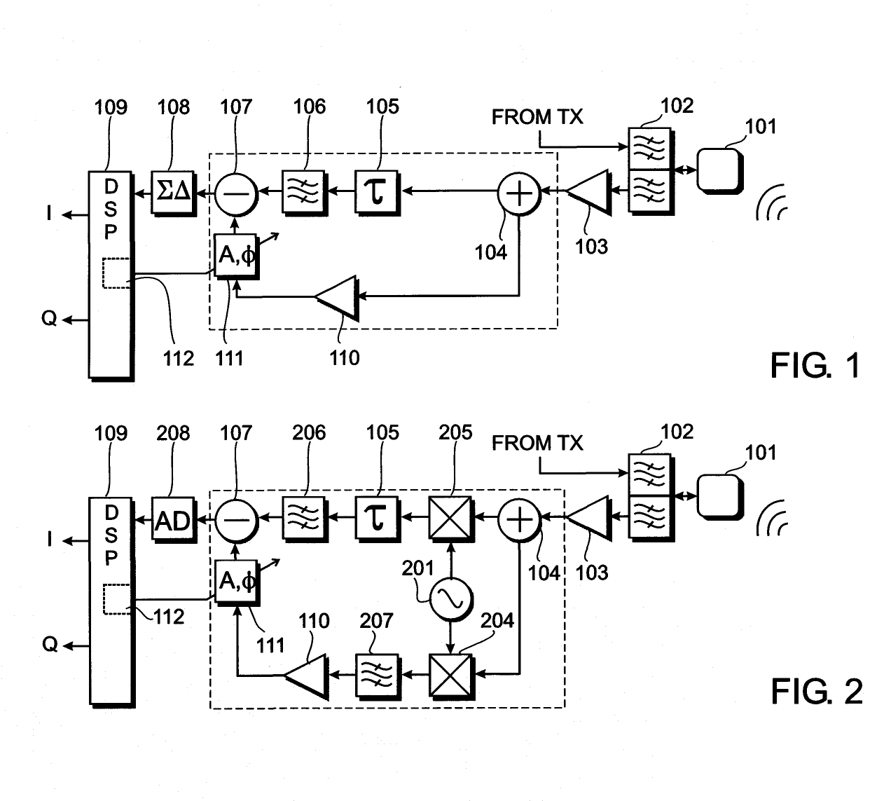

FIG. 1 shows a receiver arrangement or a receive path that may be used in a base-station of a mobile communications network. A signal from a remote transmitter is received at an antenna 101. The antenna 101 is connected to a duplex filter 102 that separates a transmission path from the receive path in the frequency domain. Instead of a duplex filter, other techniques may be used, such as a circulator or time multiplexing. The signal arriving from the transmission path is illustrated as the input to the upper part of the duplex filter 102. The lower part of the duplex filter 102 filters the part of the spectrum that is reserved for a receive band of the base-station in a mobile communications network. The duplex filter 102 is connected to a low noise amplifier (LNA) 103 that amplifies the filtered antenna signal to a level at which further signal processing may be performed. The output of the low noise amplifier 103 is connected to a signal splitter 104. The signal splitter 104 distributes the signal received from the LNA 103 to a first signal path and a second signal path. The first signal path comprises a delay element 105 and a bandpass filter 106. The second signal path (blocker cancellation path) comprises a buffer amplifier 110 and a gain/phase controller 111. An alternative to the gain/phase controller 110 is a vector modulator. The upper signal path in FIG. 1 may be regarded as a main receive path and the lower signal path may be regarded as a blocker cancellation path. In the blocker cancellation path the signal undergoes some buffer amplification in the buffer amplifier 110 to overcome the losses in the gain/phase controller 111. The signal in the main receive path, meanwhile, has undergone receive-bandpass filtering in the bandpass filter 106 and, if required, a further time delay in the delay element 105. Depending on the circumstances, the time delay introduced by the bandpass filter 106 might already be sufficient for the purposes of interference signal cancellation so that the bandpass filter 106, in this case, also assumes the role of the delay element 105. The first signal path and the second signal path are both connected to a signal combiner 107 in which the signal in the second signal path is subtracted from or added to the signal in the first signal path. Due to the time delay in the first signal processing path the two signals arriving at the signal combiner 107 will have experienced very different path delays so that the cancellation achieved can be assumed to be narrow band. The cancellation can be tuned by the gain/phase controller 111 to cancel the blocker leaving the wanted signals relatively untouched. Leaving the wanted signals relatively untouched while significantly reducing the blocker is assumed to be possible due to the achieved narrow band cancellation, even if the blocker signal is spaced only a few megahertz away from the wanted signals.

An output of the signal combiner 107 is connected to an analogue-to-digital converter 108 which is assumed to be of a delta-sigma type in FIG. 1. Other types of analogue-to-digital converters may be used, as will be illustrated and explained below. The delta-sigma modulator 108 in the receiver arrangement shown in FIG. 1 converts an analogue signal received from the signal combiner 107 to a digital signal that may be processed by a digital signal processor (DSP) 109. Another function of the delta-sigma modulator 108 may be a frequency translation from a radio frequency (RF) of the analogue signal to a base band frequency or an intermediate frequency (IF) of the digital signal. In a software-defined radio system the DSP 109 may now perform any necessary action to extract one or several payload signals from a digitised signal generated by the delta-sigma modulator 108. The DSP 109 may output the payload signal in the form of an in-phase component I and a quadrature component Q. The DSP 109 may also perform one or several functions relative to the interference signal cancellation achieved by the interference signal cancellation device. For example, the quality of the cancellation process can be assessed by the DSP 109, based upon the level of residual blocker signal remaining in the converted received signal. The DSP 109 can then adjust the gain and phase controllers, as required, improving or optimizing cancellation of the blocker. This function of the DSP 109 is performed by a portion 112 of the DSP 109 or a module in the programming of the DSP 109.

As a variation to the configuration of the interference signal cancellation device illustrated in FIG. 1, the time delay element could also be located in the lower path. In this position, the value of the time delay would take account of the delay in the receive bandpass filter 106 so that a relative delay between the first signal and the second signal corresponds to the required delay for achieving cancellation of the blocker signal.

FIG. 2 shows a similar arrangement to that of FIG. 1, except that in this case a conventional analogue-to-digital converter 208 is assumed together with a single-stage of analogue down conversion and a digital input to the DSP 109 at an intermediary frequency IF. Elements in FIG. 2 that are substantially identical or equivalent to corresponding elements illustrated in FIG. 1 bear the same reference numerals and will normally not be explained again. This also applies to the other figures.

The first signal path in FIG. 2 comprises a mixer 205, for example a down conversation mixer. Likewise, the second signal path comprises a mixer 204. Both mixers 204 and 205 receive a local oscillator signal from a local oscillator 201. The first signal path now comprises an IF bandpass filter 206 instead of the bandpass filter 106. The second signal path comprises also an IF bandpass filter 207. The IF bandpass filters 206 and 207 are relatively wideband. The basic operation of the receiver arrangement shown in FIG. 2 is the same as that described in connection with FIG. 1, with the exception that subtraction occurs at the intermediary frequency (IF), prior to analogue-to-digital conversion,

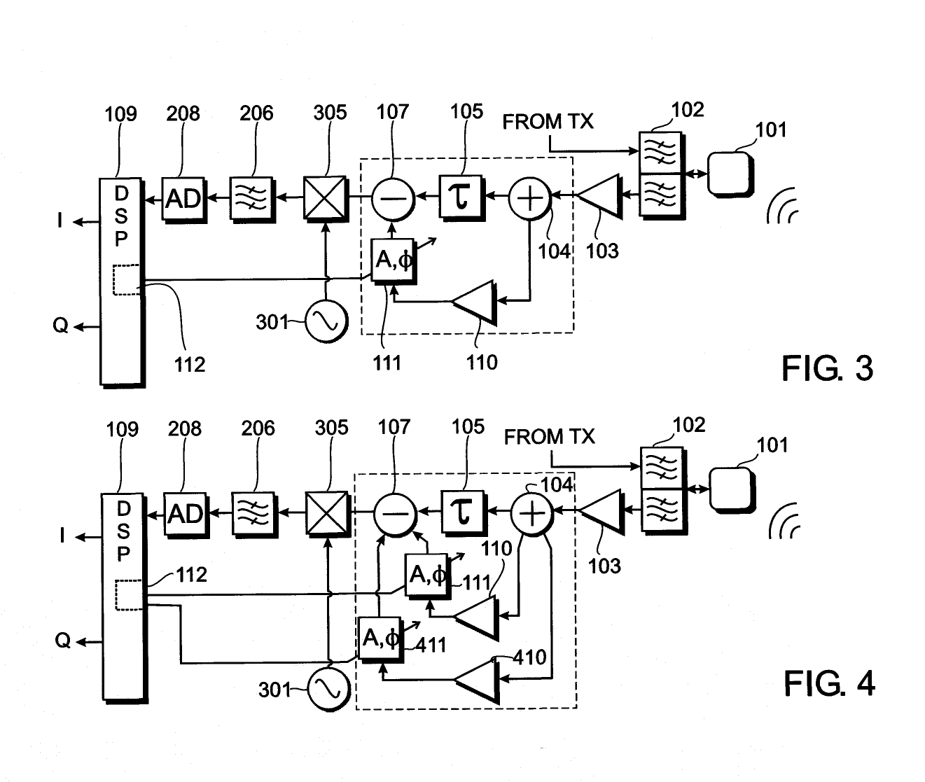

FIG. 3 shows an alternative arrangement to that of FIG. 2. In this case, the cancellation process occurs at radio frequency (RF), prior to the down conversion and filtering operations. The output of the signal combiner 107 is connected to a mixer 305 that performs a down conversion from the radio frequency to the intermediary frequency. The mixer 305 receives a local oscillator signal from a local oscillator 301. Performing the interference signal cancellation directly at radio frequency may make it possible to use a carrier wave component of the interference signal in the cancellation process. Typically, a carrier wave is relatively periodic so that a good cancellation performance may be expected.

FIG. 4 shows a receiver arrangement with a first interference signal cancellation device and a second interference cancellation device to cancel two different interference signals or blockers. The configuration of each interference signal cancellation device is similar to the configuration shown in FIG. 3. An additional blocker cancellation path comprising the second interference cancellation device is connected to the signal splitter 104. The additional blocker cancellation path comprises a buffer amplifier 410 and a gain/phase controller 411. The gain/phase controller 411 receives control signals from the cancellation controller 112 so that the additional blocker cancellation path can be adjusted to cancel a further blocker.

The principle shown in FIG. 4 may be extended to a configuration with a plurality of blocker cancellation paths to cancel a corresponding number of blockers or interference signals. In other words, the signal splitter 104 may distribute the signal received from the LNA 103 to a plurality of blocker cancellation paths.

It is also possible to duplicate or multiply the configurations of the interference cancellation device shown in FIGS. 1, 2, 5, and 6 in a manner analogous to the configuration shown in FIG. 4.

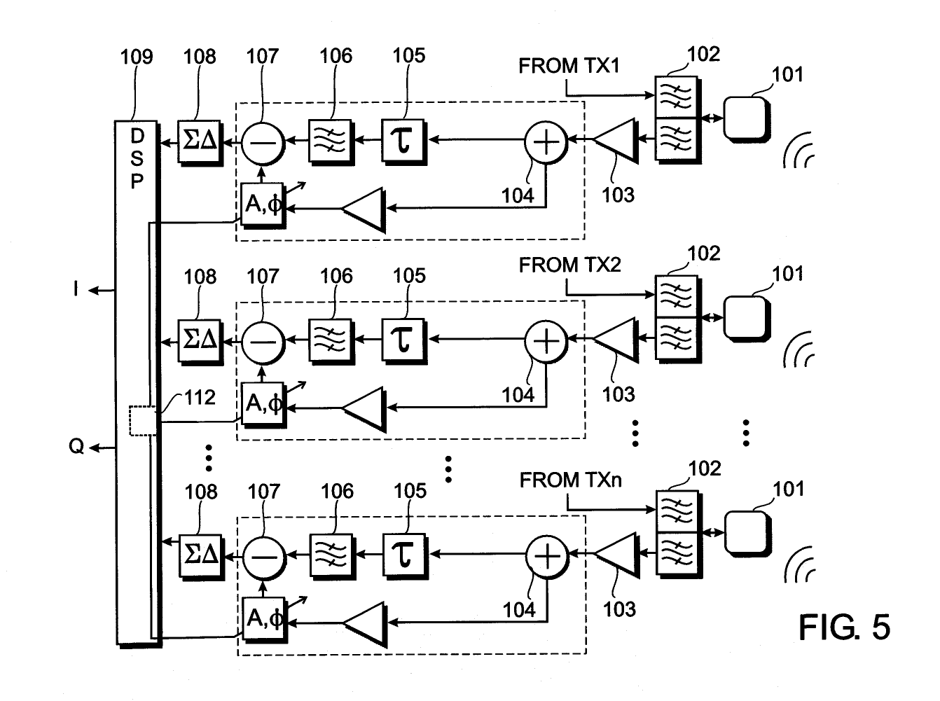

FIG. 5 extends the principles of FIG. 1 to a multi-receiver arrangement, such as that found in an antenna-embedded radio system. The multi-receiver arrangement is connected to the antenna array having n antenna elements 101. Each one of the antenna elements 101 is connected to an individual one of the plurality of receive paths via a plurality of duplex filters 102. Accordingly, the multi-receiver arrangement comprises n receive paths. Each receive path comprises an interference signal cancellation device as illustrated in FIG. 1 and as described in the context relative thereto. The different interference signal cancellation devices in the different receive paths may need to be adjusted in amplitude and phase in an individual manner, because a location of a source of the interference signal relative to the antenna array may have an influence on the amplitude and the phase relation of the interference signal. Some properties of the interference signal are, however, the same for all interference signal cancellation devices, such as the frequency of the interference signal. The digital signal processor 109 can perform a combined analysis of all signals received from the plurality of delta-sigma modulators 108 to determine whether the interference signal has been sufficiently cancelled in the various receive paths. The DSP 109 may further determine improved adjustments that are valid for all interference signal cancellation devices.

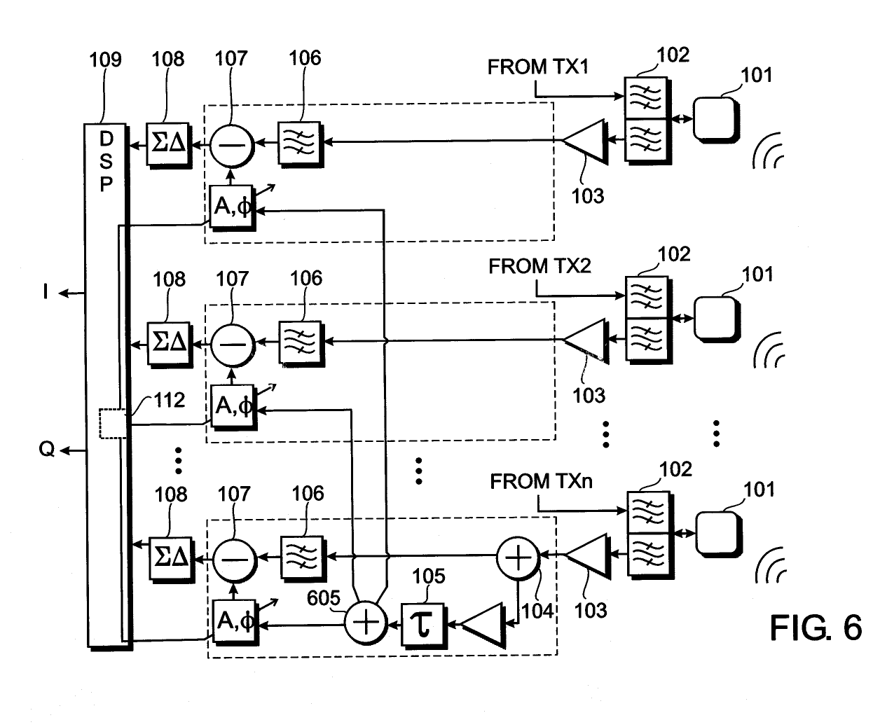

FIG. 6 shows another multi-receiver arrangement in which the interference signal cancellation device implements a “single-extraction/multiple-cancellation “scheme of the teachings disclosed herein. The identification or extraction of the interference signal is performed only once within the n′th receive path. As in FIG. 1, the signal splitter 104 distributes the signal to a first signal path and a second signal path. In contrast to the configuration shown in FIG. 1, the delay element 105 is now in the second signal path, because in this manner only a single delay element 105 is necessary, instead of n delay elements. An output of the delay element 105 in the second signal path is connected to a signal splitter 605 that distributes the second signal to a plurality of gain/phase controllers within the various receive paths. According to a gain setting and a phase setting of a corresponding one gain/phase controller within the plurality of gain/phase controllers the second signals are adjusted individually on a per-receive path basis, in order to achieve good cancellation in each of the plurality of receive paths. The adjustment of the plurality of gain settings and phase settings is performed by the cancellation controller 112 within the DSP 109.

The fact that at least a portion of the elements does not need to be duplicated on a per-receive path basis saves cost, size and weight. Once interference has been identified, the interference signal's location in the frequency spectrum can be used to control the individual gain/phase controllers for subtraction of the interference signal from each receive path.

In some configurations it may be possible to process the amplitude of the blocker only once, since it may be equal for all antenna elements—only the phase-shift element may require replication for each receiver. In this case, an amplitude controller may be placed in the common part of the interference signal cancellation device, e.g. between the time delay element 105 and the signal splitter 605. It may also be possible to omit the amplitude controller and to use the buffer amplifier 110 to adjust the amplitude.

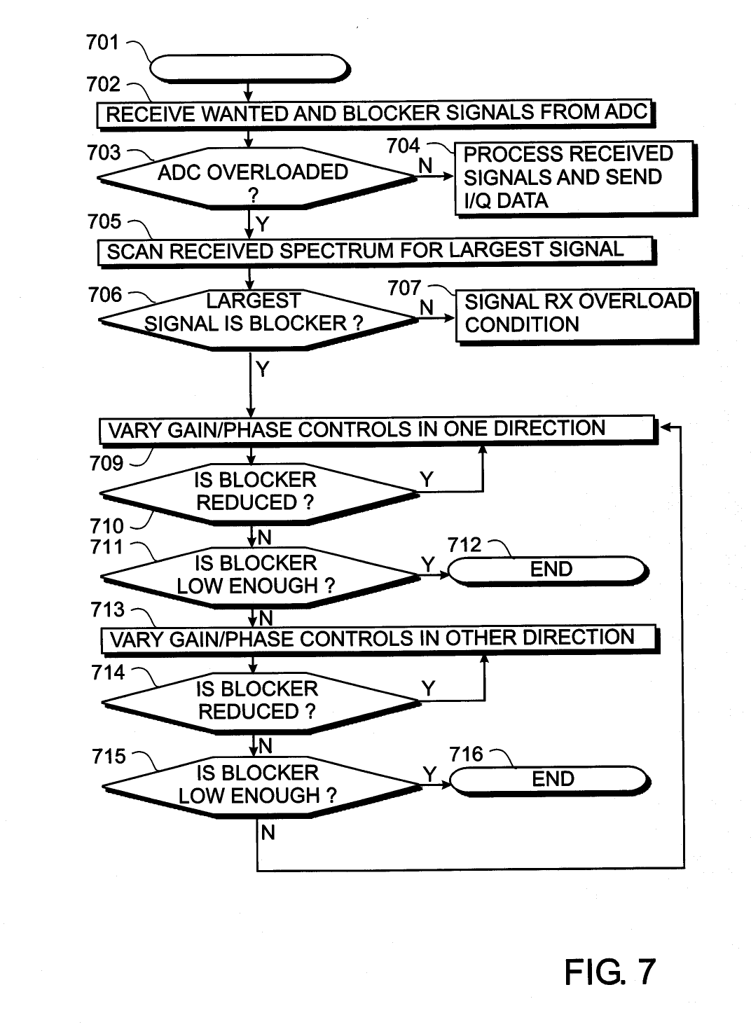

FIG. 7 illustrates one possible algorithm for the identification of an in-band blocker. The algorithm may be performed, for example, by the DSP 109 and the cancellation controller 112. At block 701 the algorithm begins. At block 702 the wanted signal(s) and the blocker signal(s) are received from the analogue-to-digital converter(s). At a decision point 703 it is determined, whether the analogue-to-digital converter(s) is/are overloaded. An in-band blocker that does not overload the analogue-to-digital converter is not a problem to the system, as this can be dealt with using the usual receiver digital filtering, for example performed by the software-defined radio system. Thus, in the case in which the analogue-to-digital converter (ADC) is not overloaded the algorithm continues with block 704 in order to process the received signals and to send the I/Q data to appropriate equipment within the base-station and/or the mobile communications network. In the other case the ADC is overloaded and the algorithm initiates, at block 705, a search for the largest signal, as this is likely to be the blocker signal.

This search for the blocker signal could take many forms, such as a Fast Fourier Transformation (FFT), plus identification of the largest value and identification of its corresponding frequency bin; a scan utilizing a digital local oscillator and digital filter, to search for the largest peak etc. Once the largest signal has been found, a quick assessment can be made, at block 706, to ascertain whether or not it is likely to be the blocker signal (e.g. whether the largest signal is in the owning-operator's frequency allocation for the product's site—if so, the largest signal is unlikely to be the blocker signal). If the largest signal is not the blocker signal the algorithm goes on to block 707 and signals a receiver overload condition to a failure management system of the base-station, for example. If, in the contrary case, the largest signal is indeed identified as the blocker signal, then the algorithm continues with block 709 to adjust the gain and the phase controls in one direction. It is, in principle, also possible to adjust the delay value to provide anti-phase cancellation.

The effect of this gain/phase variation is checked at a decision point 710. If the blocker signal could be reduced then it can be assumed that the gain/phase variation in said one direction leads to better cancellation of the blocker signal. In the contrary case it might be that a best possible minimum of level of a residual blocker signal has already been reached. This is checked at a decision point 711. The algorithm ends at a block 712, if the blocker signal is already low enough. The algorithm continues at a block 613 if the blocker signal is not yet low enough. At a block 713 it is attempted to vary the gain/phase controls in another direction. Again, it is checked whether the gain/phase variation had a positive effect on the cancellation performance, at a decision point 714. If the blocker signal could be reduced, then the method returns to a block 713 in order to perform further variation of the gain and/or the phase in said other direction. In the other case, the algorithm goes on at a decision point 715 where it is determined whether the blocker signal is already low enough. If the blocker signal is low enough, the algorithm ends at block 716. In the contrary case, the algorithm jumps back to the block 709 to attempt another variation of the gain and/or the phase controls in said one direction. The algorithm will run periodically to check whether the blocker has reduced in level or disappeared or whether a new blocker has appeared and will act accordingly, as just described.

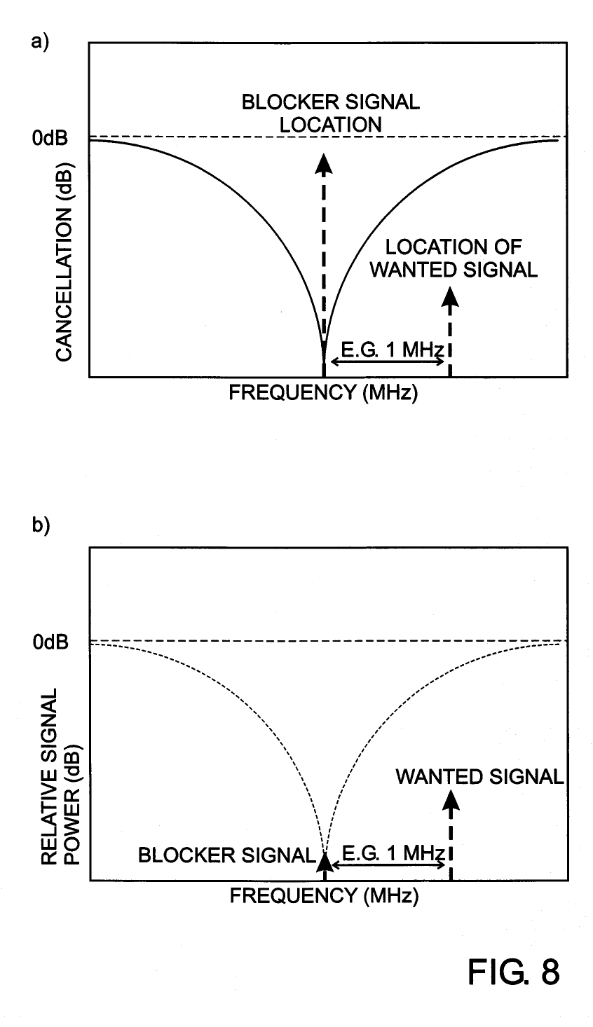

Diagram a in FIG. 8 illustrates the form of the cancellation characteristic which results from an intentional delay mismatch in a cancellation process. The width of the notch is determined by the number of cycles of delaying mismatch—the greater the number of cycles the narrower the notch width.

Diagram b in FIG. 8 shows the impact of this notch upon the blocker signal and a wanted signal: the blocker signal is significantly attenuated (40-50 dB is realistic for a narrow band, e.g. GSM blocker) and the wanted signal remains virtually untouched. A GSM blocker test according to the specifications takes place with a blocker offset of at least 1 MHz from the wanted carrier (3 MHz for the more stringent requirements). This distance in the frequency between the wanted signal and the blocker signal allows a realistic notch width to have a significant impact upon the blocker signal, but little or no impact upon the wanted signal. The mathematical derivation of the time delay required for a given level of cancellation, at a given frequency offset from “perfect” cancellation, can be found in the text book “High Linearity RF Amplifier Design “by P. B. Kenington, Boston, USA: Artech House, 2000, ISBN 1580531431, Chapter 5, the entire disclosure of which is incorporated herein by reference.

While various embodiments of the present invention have been described above, it should be understood that they have been presented by way of example, and not limitation. It will be apparent to persons skilled in the relevant arts that various changes in form and detail can be made therein without departing from the scope of the invention. In addition to using hardware (e.g., within or coupled to a central processing unit (“CPU”), micro processor, micro controller, digital signal processor, processor core, system on chip (“SOC”) or any other device), implementations may also be embodied in software (e.g. computer readable code, program code, and/or instructions disposed in any form, such as source, object or machine language) disposed for example in a computer useable (e.g. readable) medium configured to store the software. Such software can enable, for example, the function, fabrication, modelling, simulation, description and/or testing of the apparatus and methods describe herein. For example, this can be accomplished through the use of general program languages (e.g., C, C++), hardware description languages (HDL) including Verilog HDL, VHDL, and so on, or other available programs. Such software can be disposed in any known computer useable medium such as semiconductor, magnetic disc, or optical disc (e.g., CD-ROM, DVD-ROM, etc.). The software can also be disposed as a computer data signal embodied in a computer useable (e.g. readable) transmission medium (e.g., carrier wave or any other medium including digital, optical, analogue-based medium). Embodiments of the present invention may include methods of providing the apparatus described herein by providing software describing the apparatus and subsequently transmitting the software as a computer data signal over a communication network including the internet and intranets.

It is understood that the apparatus and method describe herein may be included in a semiconductor intellectual property core, such as a micro processor core (e.g., embodied in HDL) and transformed to hardware in the production of integrated sequels. Additionally, the apparatus and methods described herein may be embodied as a combination of hardware and software. Thus, the present invention should not be limited by any of the above-described exemplary embodiments, but should be defined only in accordance with the following claims and their equivalents.

1. An interference signal cancellation device comprising:
a signal splitter for distributing a disturbed signal to a first signal path and a second signal path, the first signal path and the second signal path having substantially linear behaviour;
a delay element in at least one of the first signal path and the second signal path for introducing a relative delay between a first signal in the first signal path and a second signal in the second signal path; and
a signal combiner for combining the first signal and the second signal;
wherein an interference signal within the disturbed signal is substantially reduced within the signal combiner due to the relative delay.

2. The interference signal cancellation device according to claim 1, wherein at least one of the first signal path and the second signal path comprises a filter.

3. The interference signal cancellation device according to claim 1, wherein at least one of the first signal path and the second signal path comprises at least one of a gain controller and a phase controller for adjusting at least one of an amplitude of the first signal, a phase of the first signal, an amplitude of the second signal and a phase of the second signal.

4. The interference signal cancellation device according to claim 1, wherein at least one of the first signal path and the second signal path comprises a vector modulator for adjusting at least one of an amplitude of the first signal, a phase of the first signal, an amplitude of the second signal and a phase of the second signal.

5. The interference cancellation device according to claim 1, wherein at least one of the first signal path and the second signal path comprises an amplifier.

6. The interference signal cancellation device according to claim 1, wherein the delay element has an adjustable delay.

7. The interference signal cancellation device according to claim 1, further comprising a cancellation controller, and wherein at least one of the first signal path and the second signal path comprises at least one of a gain controller and a phase controller for adjusting at least one of an amplitude of the first signal, a phase of the first signal, an amplitude of the second signal and a phase of the second signal, and wherein the cancellation controller is adapted to control said adjusting of at least one of the amplitude of the first signal, the phase of the first signal, the amplitude of the second signal and the phase of the second signal.

8. The interference signal cancellation device according to claim 7, wherein the cancellation controller controls a plurality of at least one of gain controllers and phase controllers, each gain controller or phase controller being part of an individual receive path in a group of similar or identical receive paths.

9. The interference signal cancellation device according to claim 1, wherein the interference signal is an in-band blocker.

10. The interference signal cancellation device according to claim 1, wherein the interference signal is an out-of-band blocker.

11. The interference signal cancellation device according to claim 1 for a plurality of similar or identical receive paths, wherein the interference cancellation device further comprises an interference signal splitter and additional signal combiners in each of the plurality of receive paths,
wherein the interference signal splitter is adapted to distribute the first signal to the plurality of additional signal combiners, and
wherein the additional signal combiners are adapted to combine the distributed first signal with distributed second signals, each relayed by one of the plurality of receive paths.

12. The interference cancellation device according to claim 11, wherein the delay element introduces a portion of the relative delay, the portion being common for several receive paths among the plurality of receive paths.

13. The interference signal cancellation device according to claim 11, further comprising a plurality of at least one of gain controllers and phase controllers acting on the distributed first signal.

14. A method for interference cancellation on a disturbed signal comprising an interference signal, the method comprising:
splitting the disturbed signal into a first signal and a second signal, time delaying at least one of the first signal and the second signal by a relative delay between the first signal and the second signal,
combining the first signal and the second signal for substantially reducing the interference signal within the disturbed signal due to the relative delay,
wherein the first signal and the second signal undergo substantially only linear processing between splitting and combining.

15. The method according to claim 14, further comprising
identifying an interference signal by at least one of frequency, amplitude and phase,
adjusting the relative delay between the first signal and the second signal so as to optimize the cancelling of the interference signal.

16. The method according to claim 15, wherein identifying an interference signal comprises determining whether the disturbed signal causes an overload.

17. A computer program product embodied on a computer-readable medium and the computer-readable medium comprising executable instructions for the manufacture of an interference cancellation device comprising:
a signal splitter for distributing a disturbed signal to first signal path and a second signal path, the first signal path and the second signal path having substantially linear behaviour;
a delay element in at least one of the first signal path and the second signal path for introducing a relative delay between an first signal in the first signal path and a second signal in the second signal path;
a signal combiner for combining the first signal and the second signal;
wherein an interference signal within the disturbed signal is substantially cancelled within the signal combiner due to the introduced delay.

18. A computer program product comprising instructions that enable a processor to carry out a method comprising:
splitting a disturbed signal into a first signal and a second signal,
time delaying at least one of the first and the second signal,
combining the first and the second signal to cancel an interference signal within the disturbed signal due to the introduced delay,
wherein the first signal and the second signal undergo substantially only linear processing between splitting and combining
